(19) United States
(12) Patent Application Publication
(10) Pub. No.: US 2025/0193137 A1
(43) Pub. Date: Jun. 12, 2025

(54) SATELLITE COMMUNICATION SYSTEM

(71) Applicant: Commcrete Ltd., Hevel Modi’in (IL)

(72) Inventors: Joshua Yedidia, Ramat Gan (IL); Itzik Daniel Michaeli, Sde David (IL); Michael Mor, Petah Tikva (IL)

(21) Appl. No.: 18/796,943

(22) Filed: Aug. 7, 2024

Related U.S. Application Data
(60) Provisional application No. 63/607,125, filed on Dec. 7, 2023.

(51) Int. Cl. H04L 51/04; H04B 1/69; H04B 7/185; H04L 51/58

(52) U.S. Cl. CPC H04L 51/04; H04B 1/69; H04B 7/18517; H04L 51/58; H04B 2001/6912

(57) ABSTRACT

A satellite communication system includes a server system and a transceiver array communicatively positioned between the server system and a satellite ground station. The transceiver array is operable to receive a modulated signal from the satellite via the satellite ground station, demodulate the signal into a digital packet, and send the digital packet via internet protocol (IP) to the server system. The server system reads an identify of a recipient device from the packet and operates the transceiver array to modulate the packet by spread spectrum modulation and send the packet to the recipient device via a designated band of frequency of spectrum to a satellite.

### BACKGROUND OF THE INVENTION

Cellular phone calls are conducted over radio frequency (RF) connections between one cell phone and a nearby cell tower, where a base transceiver station converts the RF signal to digital information that is sent over cellular network that may include physical cables and or wireless links. The digital information may be passed to another cellular network maintained by a different service provider and may even be passed onto a network that provides an analog signal for landlines. As long as a second phone is connected to one of those interconnected networks, two people may have a conversation.

Those communication technologies are an essential part of how people around the globe conduct their lives. Business transactions are negotiated over communication technologies. People send happy birthday messages and ask after loved ones. People facing emergencies may call for help. Some companies use telecom-based logistics to manage operators, inventories, and fleets of vehicles. Military and first responder teams rely on telecom technologies.

When a person is outside of the reach of any cellular network, landline, or internet connections, communication options are limited. There are some products, self-described satellite phones, that promise to conduct calls by RF communication with satellites. Existing satellite phones have significant limits. They typically require powerful antennae with direct line-of-sight to a satellite. They work poorly indoors, among mountains, or in forests. Due to how signals are managed, connection speeds are low and communications may suffer a notable delay. Some conventional satellite phones use the Global System for Mobile Communication (GSM), which involves a Gaussian Minimum Shift Keying modulation with a channel spacing of 200 kHz, which is resource intensive and not conducive to multiplexing. Moreover, conventional satellite communication protocols are potentially subject to high signal propagation loss (resulting in weaker signal), significant latency, and interception by third parties.

### SUMMARY OF THE INVENTION

The invention provides systems that facilitate communication over satellite and telephone networks. Systems operations are managed by a server system (which may itself be one or any number of inter-connected server computers and/or cloud computing services). The server system maintains records of, and mediates communication among, system users and their in-system devices and software. The system users are provided with their own satellite communication devices, which devices can pair with a system-provides software application (“app”) that runs on a smartphone or similar such local (“proximal”) computing device with the user. The satellite communication devices, which may be dispersed remotely about the globe, cooperate with the paired app to send and receive voice and data. When cellular networks are available, the app sends a communication (voice or data) via cellular network. When no cellular network is available, the app passes the communication as a digital packet to the paired device which uses chirp spread spectrum (CSS) modulation or similar and sends the packet within a designated band (e.g., L, S, C, X, Ku, Ka, Q, or V or similar) of frequency of a satellite.

While the signal may be sent from one device to a satellite and directly to a recipient device, most communications are mediated by the server system. To that end, systems of the invention provide a transceiver array that is communicatively positioned between the server system and a satellite ground station. The transceiver array is a hardware assemblage with a number of transceiver subunits. Within the transceiver array, each transceiver subunit has components that mirror the components of the remotely-distributed satellite communication devices. That is, each transceiver subunit has a microcontroller unit (MCU) coupled to one more RF modulation units (e.g., for modulation by a suitable waveform such as CSS) connect by send and receive sections to a high-gain antenna that sends or receives in the designated band of frequency. The transceiver array activates a number of the transceiver subunits commensurate with instantaneous demand.

For example, if one user in a forest in Brazil uses push-to-talk (PTT) on her smartphone to speak to her colleague on a remote island, the app on her smartphone will encode her comment as a digital packet (optionally also compress and encrypt the packet) and pass it to her device which performs CSS modulation and sends a signal via a designated band (e.g., L-band) to a satellite. The satellite will downlink the signal to a satellite base station (e.g., with a large dish antenna at a facility of the satellite company). The transceiver array will activate one transceiver subunit to receive the signal from the satellite ground station, recover the digital packet and send that via IP to the server system. The server system reads the identity of the recipient from the packet and recapitulates the chain of operations in the “reverse” direction, having the transceiver array perform CSS or similar modulation and send the signal by satellite to the remote island.

In a contrasting example, if the communicating end-users are hundreds of light-trucks in a fleet in which each truck is scheduled to report location status information every hour, then the transceiver array will “spin up” dozens or hundreds of transceiver subunits each hour to receive the incoming location status reports and lodge those with the server system.

As mentioned, each of the remote devices and each subunit of the transceiver array performs radio frequency (RF) modulation and satellite communication using system hardware. Preferred embodiments use an RF modulation technique associated with Internet-of-things (IoT) devices and convert the signals into an L-band frequency of a geostationary (GEO) satellite system. The modulation may involve amplitude shift keying (ASK), phase shift keying (PSK), frequency shift keying (FSK), or CSS. A preferred embodiment that is operational involves CSS and may be implemented using the CSS standard known as LoRa (for “long range”). Thus, each remote devices and each subunit of the transceiver array may have at least one LoRa transceiver (each device may have three or more, e.g. high-rate general purpose, a high-rate push-to-talk (PTT), and low rate general purpose). Using that hardware, a modulated digital packet may occupy less than about 7.8 KHz of spectrum (even much less) allowing signals to be multiplexed to send three more, even as many as twelve, signals simultaneously on 25 KHz band of a channel of a satellite. The transceiver array relays those signals to the server system, which functions as the administrative center of systems of the invention.

When an end-user wants to use the system, they may first register their satellite communication device with the server system. The server system may also provide the app for download to the remote computing device (e.g., smartphone), to be installed and paired with the device. The device and its paired app is assigned a user ID by the server system, and the server system may maintain a user account for the user ID. The user account facilitates billing and other admin functions and may also be used for group membership. Users may create or join groups (which are assigned a group ID) and communication may be via group ID. Communications are sent as digital packets which include a block of bytes for recipient, which may be a user ID or group ID. Each communication is effectively broadcast and sending to a large group (e.g., every soldier in a battalion) does not require sending multiple messages over multiple satellite channels. Once message is sent and every receiving device, if its user ID is a member of the recipient group ID, demodulates the signal and transfers the digital packet to the paired app.

The server system also manages the assignment communication channels and can provide the registered device with information about satellite beams. The server can poll any device for its current location, which it determines by GPS and returns to the server. The server can, by the GPS data, determine what beam of a satellite is available to the device and assign the device a channel (a specific band of spectrum) of that beam of the satellite to use for communication.

The server system thus tracks what users and what numbers of users are occupying each beam of the satellite (and can assign changes to distribute devices to more channels). The server also plays an important role in managing routing among satellite, cellular, and IP networks. It is important to note that systems of the invention can use satellite networks when cellular networks are not available to an end-user. But it is also important to note that any single communication may pass along any or all three of satellite, cellular, and IP networks. It would be a mis-understanding to suggest that the server system chooses which of cellular versus satellite is available. It is a more correct description to state that the server system uses satellite, cellular, and IP networks to ensure that one communication goes from sender to recipient and also that many (e.g., millions) of daily communications pass from their senders to their recipients.

Not only does systems of the invention make use of a top-level server system as described, some embodiments described herein also make further use of what is referred to as a hub computer. A hub computer offers much of the same functionality as the described server system and the hub computer is typically provided with, and connected to, its own transceiver array. However, the hub computer may supplement the server and facilitate rapid and reliable communication by adding geographical proximity and engineering redundancy to operation of the system. For example, if the server system is principally located at a data center in Netherlands, and supplemented at peak demand by cloud computing instances provided by third-party vendors, and if a shipping company is making intensive use the device in a fleet of vessels in and around Taiwan, the shipping company may install a hub computer in Hong Kong with proximity to an Inmarsat base station. The hub computer may communication with the satellite base station in Hong Kong by a transceiver array and also communicate with the data center in the Netherlands by IP. In this example, the hub computer offers much of the same functionality as the server system, but ensures rapid and reliable communication among the fleet of vessels with a layer of redundancy.

Thus, any included hub computer, its local transceiver array, the server system, any transceiver arrays of the server system, the remote satellite communication devices, the software app that each may be paired with, all together constitute systems of the invention.

In certain aspects, the invention provides a satellite communication system that includes a server system having stored therein identities of a plurality of satellite communication devices and a transceiver array communicatively positioned between the server system and a satellite ground station receiving transmissions from a satellite. The transceiver array is operable to receive a modulated signal from the satellite via the satellite ground station, demodulate the signal into a digital packet, and send the digital packet via internet protocol (IP) to the server system. The server system reads an identify of a recipient device from the packet and operates the transceiver array to modulate the packet by spread spectrum modulation and send the packet to the recipient device via satellite. The spread spectrum modulated signal may use about 8 KHz of spectrum or less. The satellite may communicate with the satellite communication devices by a plurality of beams, in which each satellite channel has a bandwidth of about 25 KHz such that the server system is operable to use the transceiver array to simultaneously send multiple signals using one beam of the satellite. Communication via the system may operate at a data rate from about 1 kbit to 120 kbit (i.e., 1 kbps to about 120 kbps), e.g., when the nominal data rate would be about 1-5 kbs without the spread spectrum encoding.

Preferably the transceiver array comprises a plurality of hardware satellite communication devices. Each of those hardware satellite communication devices may have its own microcontroller unit coupled to a transceiver unit, whereby each device can simultaneously send or receive at least about three packets. The transceiver array can operate the plurality of hardware satellite communication devices to simultaneously send or receive dozens or more of the packets.

Systems of the invention may include a hub, the hub including a transceiver device coupled to a local hub computer. The hub is remote from any satellite ground station and operates to relay a transmission from a first device to a second device of the plurality of satellite communication devices through a satellite using a first channel on a satellite beam for the first device and a second channel on the satellite beam or the second device. The hub may communicate the transmission via chirp spread spectrum modulation, phase shift keying, frequency shift keying or amplitude shift keying modulation with the satellite in the designated band of frequency, which may be the L, S, C, X, Ku, Ka, Q, or V band (e.g., preferably the L-band or C-Band). In some embodiments, the hub demodulates the transmission to read a digital packet, in which a header of the packet identifies the second device as an intended recipient. The hub may verify, e.g., using a database and/or GPS on the second device, that the second device is within the satellite beam.

Systems of the invention may include at least one device of the plurality of satellite communication devices. The device includes (i) a transceiver unit operable to transmit a message from the one device to the satellite, (ii) a controller unit coupled to the transceiver unit and operable to control operations of the transceiver unit, and (iii) a connection subsystem that communicatively couples the device with a local computer device. An app may be provided on the local computing device such as a smartphone, tablet, or similar that is paired with the device. The app offers an end-user the ability to use the one device for push-to-talk communication and text messaging.

Using the system, an end-user may use the mobile app to compose and send a text message from the local (“proximal”) computing device (e.g., smartphone, tablet, etc.) to a second device of the plurality of satellite communication devices. The app writes the text message as a digital packet and sends the digital packet from the proximal computing device via a personal area network (PAN) or wired (e.g., USB) connection to the paired device. The local computing device such as the smartphone, laptop, or tablet is proximal when it is within range of the PAN or wired connection. The paired device receives the digital packet, generates (using e.g., chirp spread spectrum modulation, phase shift keying, and amplitude shift keying) an RF signal that contains the digital packet, and sends the RF signal via a designated band of frequency (e.g., the L-Band) to the satellite. In preferred embodiments, the PAN connection is a Bluetooth low energy (BLE) connection.

Using the system, the satellite sends the RF signal to the satellite ground station. The transceiver array relays the digital packet to the server system. When an end-user selects a message recipient using the mobile app, the mobile app encodes the recipient in bits within the digital packet. The server system may identify the recipient as a registered user of the system and route the digital packet to a receiving one of the plurality of satellite communication devices being used by the message recipient.

In certain embodiments, the mobile app determines that a cellular network is available to the local computing device and the mobile app sends the message to the server system via the cellular network. In some embodiments, the one device and a second device of the plurality of satellite communication devices are both registered in the server system and when the one device and second device are within a beam of the satellite, the one device and the second device can send messages to each other via only the satellite without the message passing through the server system, the transceiver array, or a terrestrial hub.

In some embodiments, the one device and the recipient are both registered in the server system and when the one device is within a beam of the satellite and when the recipient has a computing device (e.g., smartphone) within a cellular network, the one device sends a message via the satellite to through the server system, onto the cellular network and to the recipient computing device. In certain embodiments, the one device performs chirp spread spectrum modulation on a digital packet that includes bits identifying the second device and sends the modulated digital packet via the L-band to the satellite, at which point the satellite performs a bent-pipe return to pass the modulated digital packet via the L-band to the second device, which second device reads the bits identifying the second device and passes the digital packet via BLE to a second smartphone. Also, when the one device and second device are within a cellular network, the devices may communicate via the cellular network.

The one device and a second device (both registered in the server system) may exchange messages by each of the following routings according to availability of system components: (i) the one device to the second device via single 25 KHz channel through one satellite acting as a bent pipe; (ii) the one device to the second device via a terrestrial hub using two 25 KHz channels; (ii) first smartphone paired to the one device to second smartphone paired to the second device via cellular network; (iii) the one device to the second device through the satellite ground station, the transceiver array, and the server system; and (iv) the one device to the second smartphone paired to the second device by sending pre-programmed message stored in memory of the one device to the satellite via L-Band.

In certain applications, one or more of the plurality of satellite communication devices are installed on vehicles (or vessels) of a fleet. The server system may track locations of the vehicles of the fleet using GPS information from the plurality of satellite communication devices.

In various embodiments, the server system and/or each device maintains a database representing geographical extent of beams of the satellite as polygons. Each of the plurality of satellite communication devices operates to change a beam using a global positioning system (GPS) or a Global Navigation Satellite System (GNSS) coupled to a controller unit within the device. In a device, the controller unit is operable to obtain coordinates for a current location of the device from the GPS and select from the polygons an active polygon representing an active beam of the satellite within which to transmit the message. The server system may maintain a user ID for each of the stored identities of the plurality of satellite communication devices, each user ID being associated with a user. The server system may allow each user ID to be associated with one or more group IDs and the digital packet may include a user ID or group ID as the recipient.

### BRIEF DESCRIPTION OF THE DRAWINGS

FIG. 1 shows a device for communicating via satellite.

FIG. 2 is a high level schematic drawing of components of the device.

FIG. 3 is an overview of a satellite communication system.

FIG. 4 diagrams elements of a system.

FIG. 5 shows a transceiver array at a site of a satellite ground station.

FIG. 6 diagrams how the system will route a message.

FIG. 7 shows steps of a communication method.

FIG. 8 diagrams components of a satellite communication device.

FIG. 9 is a block diagram of a printed circuit board assembly.

FIG. 10 shows elements of a transceiver unit.

FIG. 11 diagrams elements of a digital packet.

FIG. 12 illustrates how several signals may share a channel.

FIG. 13 shows sending via satellite with no hub computer.

FIG. 14 shows a hub computer using a transceiver array.

FIG. 15 illustrates a home screen of an app.

FIG. 16 illustrates an app screen for SOS messaging.

FIG. 17 shows a screen of an app.

FIG. 18 shows communication paths for messages.

FIG. 19 illustrates part of software architecture.

### DETAILED DESCRIPTION

The disclosure provides devices, systems, and methods for communication via satellite and cellular networks using a compact, custom-built device that sends various forms of communication, including voice, text, location information, and pre-set messages to one or more intended recipients via those satellite or cellular networks depending on availability. A satellite communication device of the disclosure “pairs with” a local computing device such as a smartphone. An app on the computing device offers an interface by which a user may initiate and receive communication. The app on the computing device (e.g., smartphone) passes a communication, as a digital packet, via a personal area network (PAN) connection such as a Bluetooth low energy (BLE) or wired connection to the satellite communication device. The satellite communication device includes a controller and transceiver by which the device modulates the digital packet onto a carrier wave and sends the modulated carrier wave as a signal to a satellite (e.g., when a cellular network is not available to the computing device).

The satellite communication device preferably encodes the packet in the signal by a modulation technique suitable for internet-of-things (IoT) connectivity. For example, the modulation technique may include amplitude shift keying, frequency shift keying, phase shift keying, or chirp spread spectrum (CSS) modulation. In one illustrative embodiment, the modulation technique is a CSS modulation that conforms to the LoRa (for “long range”) standard, which is used for IoT devices. The satellite communication device sends the modulated signal according to the modulation waveform within a designated band of frequency (e.g., the L-Band) of spectrum. For that purpose, the satellite communication device preferably includes a high-gain antenna connected via transmit and/or receive sections to one or more transceiver units that perform the modulation to encode the digital packet in the waveform. Thus a chirp spread spectrum wave form encoding a digital packet is transmitted from the satellite communication device paired with the computing device (e.g., smartphone) within the designated band of frequency to a satellite such as a geostationary (GEO) satellite.

Devices and systems of the invention provide for voice communication, e.g., by push-to-talk (PTT), text communication, and location sharing/requests via Geostationary satellites. Such functionality is available when and where no other communication options are available for one or more of the communicating parties.

Systems of the invention encompass satellite communication devices, a mobile application available for both Android and iOS platforms, and server system (which may include cloud-based resources and/or server computers in any combination). The satellite communication device can operate autonomously, functioning as a standalone solution for tasks such as location sharing (utilizing GPS, GNSS, and Gallio Satellite systems), SOS functionality, and predefined messaging. For standalone functionality, the satellite communication device need not be paired with a smartphone or other local computing device. Additionally, the satellite communication device has the capability to seamlessly pair with a smartphone or other local computing device through Bluetooth low energy (BLE) connectivity, offering users access to a Graphical User Interface (GUI) via an accompanying software application, or “app”. The accompanying application enhances user experience by providing several valuable features including, but not limited to: (a) real-time Push-to-Talk (PTT) functionality; (b) real-time messaging capabilities; (c) a user-friendly interface for viewing message correspondences; and (d) various additional functionalities.

A satellite communication device of the disclosure provides the ability to maintain communication even in adverse weather conditions and within enclosed structures, all without requiring precise satellite aiming. Systems and methods of the invention have a wide range of applications including, for example, for the management of communications for: (a) vehicle fleets (e.g., business-to-business (B2B) communications among mobile platform fleets); consumer communication (e.g., to travelers, in national parks and monuments or other parks or campuses); and (c) public safety and homeland security (e.g., mobile to stationary communications with headquarters; among dispersed devices to be carried remotely by soldiers/first responders). Such distinct user segments exemplify the versatile applications and adaptability of the satellite communication device in serving a range of commercial, consumer, and homeland security needs. The present invention provides communication systems, specifically devices and terrestrial systems that use not only cellular networks and internet protocols but also narrowband satellite communication equipment and technologies.

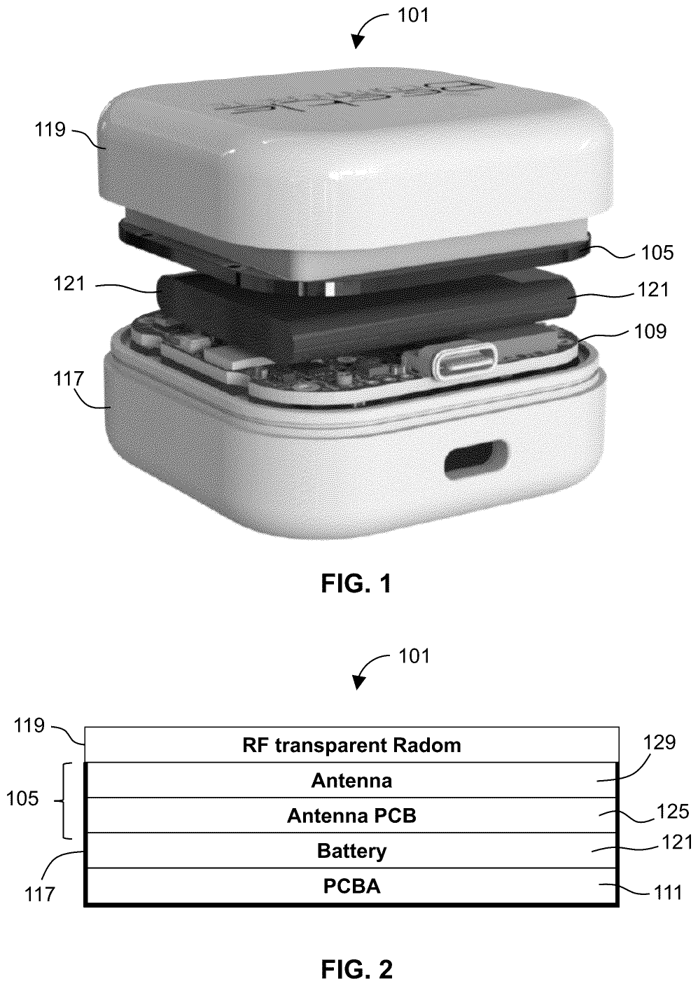

FIG. 1 shows a device 101 for communicating via satellite. The device 101 includes a transceiver unit 105 and a controller unit 109 coupled to the transceiver unit. The transceiver unit 105 is operable to transmit a signal comprising a packet encoded by modulation of a carrier wave from the device to a satellite. The controller unit 109 is operable to control operations of the transceiver unit as well as a personal area network (PAN) or wired (e.g., USB) connection that communicatively couples the device with a local, or “proximal”, computing device such as a smartphone. The local computing device is proximal when it is within range of the PAN or wired connection. The transceiver unit 105 modulates a carrier wave with a digital packet to form a signal and sends the signal to a satellite. The device 101 may have any suitable form factor and the included transceiver unit may operate to communicate with any suitable available satellite. For example, the device may send and receive with low-earth orbit (LEO) satellites, medium-earth orbit (MEO) satellites, or geostationary (GEO) satellites.

Devices of the invention are provided with at least three primary applications and may have corresponding form-factors. The three primary deployments/application may be described as mobile (e.g., personal, or hand-held), tactical (e.g., military or homeland security), and mobility (e.g., automotive, or “fleet”, on vehicles or vessels).

In the mobile embodiment, the personal device 101 (pictured) that is pocket-sized (e.g., about a few cm in each dimension). Notably, the mobile versions are embodied as a handheld device 101 (as shown) with an internal battery and internal antenna. Having the battery and antenna internal allow the device 101 to operate as a fully stand-alone product.

For tactical applications, the device generally has generally the same technical components as the depicted device 101 but possibly with a ruggedized case and/or clips or interconnects for attachment to garments or vehicles. A tactical version of the device may use an external DC input and an external Antenna (active or passive), which preferably complies with military grade integrated systems (Star-Pan hub, Net Warrior interface, ATAK, etc.).

For vehicular use (“mobility” or “fleet”), the device is provided preferably with a mountable case (e.g., with flanges or rack ears to be bolted to a vehicle). In general, vehicle and tactical embodiments may either or both have connections for external power or antennae. For example, a vehicle device may have, instead of the battery 121, a line-out connection to be spliced or jacked into a 12V wiring harness of a vehicle. Similarly, a vehicle device may have a line out from an antenna printed circuit board for a line that is attached to run to an antenna (active/passive) mounted to an exterior of an exterior of a vehicle (similar to tactical application, which may splice into other, e.g., comms, power supplies or may similarly use external antennae).

The depicted embodiment of device 101 is intended for use on a person and may be carried in a pocket. The device 101 preferably has a minimum of surface interfaces or controls. The device 101 may include (among others): a data/power jack, such as a USB-C port for charging the battery 121; an LED (to indicate operation); and one or a very limited number of buttons (e.g., on/off and/or “send SOS”). Preferably, the personal device 101 does not include certain standard computer hardware such as a monitor, keyboard, cursor control device, headphone jack, etc. Such functionality may be provided by a paired local computing device (e.g., smartphone). In preferred embodiments, the device 101 is a small form-factor L-Band transceiver, designed to communicate over Geo-Stationary satellites. The systems and methods described herein allow devices to communicate over bent pipe satellite service (ViaSat L-TAC, for example). In preferred embodiments, the device 101 operates as a Software Defined Radio (SDR) with a nominal bit rate of 1 kbps (configurable) using spread spectrum waveform of 8 kHz wide signal or less over the satellite. Devices and systems of the invention send messages as digital packets encoded on a modulated waveform, in which a common message sent via systems and methods herein may last approximately 250 ms of airtime.

The device 101 preferably operates as a transceiver and not a MODEM. Therefore, its idle state is reception mode, it is not synchronized by control signals of any routing system, and the device 101 need not require GPS synchronization and the device 101 need not have any IP address. It is reachable any time by a connected system that can connect to any other device 101 configured to the same network parameters (narrow-beam, frequency, device ID).

As discussed, the device 101 preferably sends and receives within an L-Band of spectrum. Various parameters, including frequency, bandwidth, antenna design, and power, are optimized for the satellite communication systems and devices herein. For high availability, device 101 preferably utilizes a GEO satellite constellation. A GEO satellite typically employs a single high-gain antenna with multiple feed points, resulting in multiple beams being directed towards the Earth. The availability of those beams may be understood as polygons per feeder available over the surface of the Earth. One such GEO satellite covers approximately one third of the Earth's surface, and the antenna of the one satellite incorporates multiple feeders to achieve high gain across the entire area.

FIG. 2 is a schematic drawing of features of the device 101. Within the device 101, the controller unit (e.g., a microcontroller unit (MCU)) may be provided a printed circuit board assembly (PCBA) 111. The PCBA is disposed within a base shell 117 or tray providing radio frequency interference protection between the PCBA 111 and environmental signals. The device 101 may include a battery 121 or power connection connected to the PCBA 111. Preferably, the transceiver unit 105 includes an antenna printed circuit board operably (antenna PCB) 125 connected to the PCBA 111 and an antenna 129 connected to the antenna printed circuit board. The device 101 may also include an RF-transparent radome 119 (sometimes written radom) over the antenna 129. Preferably at least an active portion of the antenna extends outside of the base shell 117 or tray while being covered by the radome 119. In certain embodiments, the device 101 is a half-duplex L-Band device that utilizes LoRa or similar as its transceiver, converting it to the Satellite L-Band frequency.

The device 101 uses a high gain antenna that covers a wide (160 deg) angle, which covers most of the globe, without the need to aim for the satellite. As shown, the device 101 includes an RF-interfering (RFI) cage (e.g., shell 117) that encapsulates the PCBA 111, power supply, and antenna PCBA 125. The antenna PCBA may provide an upper RFI closure, preventing EMI from leaking out. The upper part of the device 101 is an RF-transparent radome 119, which does not affect the performance of antenna 129. The depicted design allows for a wide-angle view to a satellite, even very low elevations-when the application is in the north or south pole of the globe. Using the depicted components, the device 101 provides certain functionality. For example, the device 101 may send a communication to a second device 102 (essentially the same as device 101). Using a waveform such as a chirp spread spectrum modulation, the converted, spread spectrum message may occupy less than about 8 KHz of bandwidth.

The data rate of the device 101 may vary, ranging from 100 bps for a high signal-to-noise ratio (SNR) margin of 32 dB to 1 Kbps for an SNR margin of 22 dB. A high SNR is particularly beneficial in SOS situations where the reliability of the communication system is crucial. These SNR margins of 22-32 dB allow the device 101 to maintain availability and reliability even without precise satellite aiming, even in challenging weather conditions and within buildings. This versatility enables a wide range of applications and uses for the device 101.

The device 101 operates via interaction with a satellite communication system that uses certain in-system server systems to coordinate operations among devices 101, 102, etc.

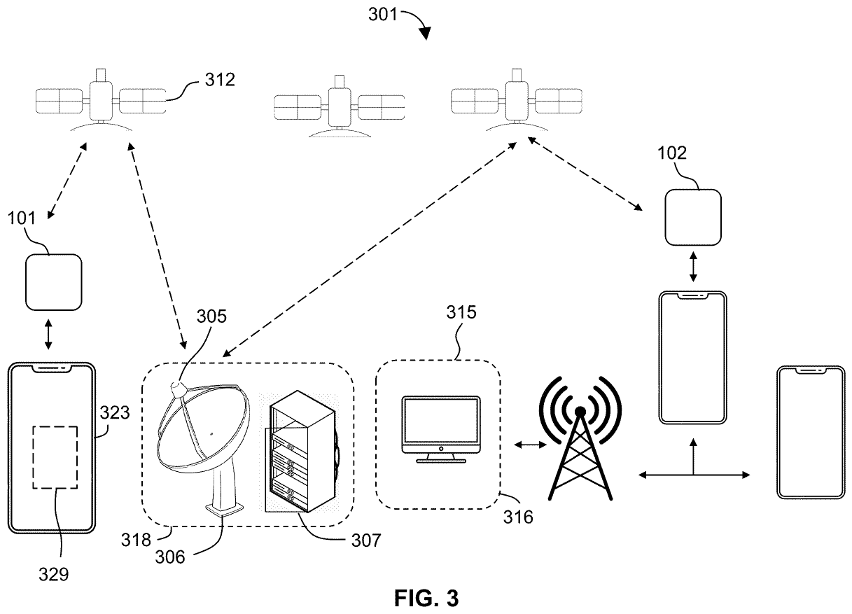

FIG. 3 is an overview of a satellite communication system 301 according to certain embodiments. As shown, the system 301 includes a server system 315 having stored therein identities of a plurality of satellite communication devices 101, 102, etc. The server system 315 maintains a database of registered users and may manage group memberships of various users and their respective devices 101. The server system may use a satellite ground station 306 to mediate communications over one or more of a satellite 312. Additionally, the server system 315 may use internet or cellular network infrastructure to communicate with devices 101 or their paired computing devices 323. For example, the server system 315 may communicate via internet or cellular network infrastructure directly with an app 329 on a computing device 323 (e.g., during installation, set-up, registration, and subsequently when such communications networks are available to the computing device 323). When the computing device 323 is not within reach of a cellular network (or other internet network), the computing device 323 may use the device 101 to send and receive via a satellite 312. The server system 315 is able to query a device 101 of the disclosure for its current status (location etc.) and configuration through the satellite 312.

The ability of the server 315 to query, or ping, a device 101 for a location or status of the device 101 is a central function of how the server system 315 manages communication via the satellite(s) 312. The server system 315 may assign (or change) a frequency band, or channel, within which a device 101 sends or receives and the server system 315 may do so based on a current available beam (provided by an antenna of the satellite 312) and channel (defined by availability of spectrum to satellite 312) usable by the device 101.

Different deployments of, and connections among, the components of system 301 are contemplated and illustrated in the subsequent passages. Preferred embodiments of the system 301 make use of a transceiver array 307 to mediate communication

At the core of certain embodiments of the system 301 sit at least one server system 315 in communication with the transceiver array 307. The server system 315 may be provided by any suitable server hardware or cloud-based resources. The transceiver array 307 is communicatively positioned between the server system 315 and a satellite ground station 306. As shown, the satellite ground station 306 receives (and may always be receiving) transmissions from a satellite 312. The transceiver array 307 is operable to receive a modulated signal from the satellite 312 via the satellite ground station 306, demodulate the signal into a digital packet, and send the digital packet to the server system 315 via at least internet protocol communication. The transceiver array 307 is not a general purpose computer at least in that the transceiver array 307 must offer the same waveform modulation and high-gain send/receive as the device 101. In fact, a first embodiment of the transceiver array 307 is a plurality devices 101 wired to a computer rack or similar controlling hardware. Thus, the transceiver array 307 preferably includes a plurality of hardware satellite communication devices (each a “Tx/Rx module”), each such device having a microcontroller unit (MCU) coupled to a transceiver unit as shown for the device 101. Each device of the transceiver array 307 can simultaneously send or receive at least about three packets. The transceiver array can operate the plurality of hardware satellite communication devices to simultaneously send or receive dozens or more of the packets.

In certain embodiments, each Tx/Rx module of the transceiver array 307 can multiplex a few to about 12 or more packets per channel of a satellite beam. The transceiver array 307 may have some number (e.g., 24 or hundreds) of the Tx/Rx module. When the server system 315 and/or dispersed devices 101 demands a number of simultaneous communications greater than the multiplexing capacity of one Tx/Rx module, the transceiver array 307 activates additional Tx/Rx modules of the available 24. If end-user demand exceeds the number of Tx/Rx modules of transceiver array 307, the transceiver array 307 is easily expanding by adding additional Tx/Rx modules. Note that each Tx/Rx module has essentially the elements of the device 101. In fact, one easy way to expand capacity of the transceiver array 307 is to simply attach additional instances of the device 101 to the transceiver array 307.

The transceiver array 307 is operable to send the digital packet via internet protocol (IP) to the server system 315. The server system 315 reads an identify of a recipient device 102 from the packet and operates the transceiver array 307 to modulate the packet by spread spectrum modulation and send the packet to the recipient device 102 via satellite 312.

The system 301 may include one or more satellite communication devices 101. Each satellite communication device 101 may include (i) a transceiver unit operable to transmit a message from the one device to the satellite, (ii) a controller unit coupled to the transceiver unit and operable to control operations of the transceiver unit, and (iii) a personal area network (PAN) connection subsystem that communicatively couples the device with a local computing device 323. The local computing device 323 preferably has therein a software application, hereinafter app 329.

A device 101 may perform “beam hopping”. With a satellite, in view of the fact that each of the polygons operates on a distinct narrow-band frequency, device 101 may use a software and hardware-based method to identify the specific polygon and extract the correct frequency for communication. The device 101 uses its GPS location data to determine its own current GPS coordinates. The device 101 may have stored in memory therein data describing polygons representing the geographical reach of beams of the satellite 312. The device 101 may also have data representing channels provided by the satellite 312 and/or frequency information (e.g., provided by server system 315) identifying which channel to use. The device 101 may use its current GPS coordinates and the data stored therein to determine what beam the device should use and when to switch from one beam to another (e.g., when, for example, the device 101 is moving over a surface of the Earth). Within the device, preferably the MCU uses GPS and stored data to determine a frequency band used by the beam of the satellite within which to transmit the message. The MCU may use the GPS and stored data to determine (i) that the device is moving among beams of the satellite and (ii) that the device should change transmission or reception from using the beam and channel of the satellite to using another (e.g., a second) beam and channel of the satellite.

That beam-hopping functionality uses GPS data in a manner similar to how the device 101 sends location data (or responds to a status query from the server system 315 or a second device 102). For location sharing, initiated at the device 101, the device 101 may include at least one mechanical trigger or button accessible on an exterior of the device that, when activated by a user, causes the MCU to: retrieve a pre-scripted message packet from a connected flash memory within the device and cause the transceiver unit encode the pre-scripted message packet using a

CSS (e.g., LoRa) waveform or similar and send the encoded packet to the satellite within the designated band of frequency. The trigger or button on the device is used for true standalone functions such as location sharing, pre-scripted message sends, or SOS signaling. Similar functionality may be initiated by app 329, paired with device 101, operating on computing device 323.

Having introduced and described the system 301 as a whole, various functions of the devices 101 may be described, making reference to the system components.

In some embodiments, the devices 101, 102 share push-to-talk functionality. A user of a device 101 may briefly interact with a “button” (or other control) on app 329 or computing device 323 and speak. The app 329 samples the sound that is spoken and encodes the sample as a digital packet. Known algorithms for condensing file sizes, including, for example, one or more band-pass filters, may performed by app 329 to minimize the size of the sample. The sample is then encoded in the digital packet and sent to the device 101.

In certain embodiments, the device 101 allows a user to send a string of text characters, i.e., a text message. The app 329 may present a “keyboard” graphic, allowing the user to key in a message. The app 329 then encodes the message as a digital packet and sends that to the device 101.

In other embodiments, the device 101 allows a user to send a pre-set or pre-scripted message. For example, in fleet embodiments, there may be a limited list of a few to a few dozen different messages that are integral to fleet operation management (i.e., arrived, in-transit, fuel low, payload delivered, behind schedule, detour required, etc.) Those messages may be pre-set within app 329 or device 101. Note that for pre-scripted messages, the device 101 may operate standalone or through app 329. When standalone, the pre-scripted messages are stored in memory on the device 101 and, when the appropriate button is pressed, is passed as a digital packet into active components of the device 101.

Embodiments of systems, methods, and devices of the disclosure provide for SOS functionality. SOS functionality may have essentially the same features as pre-scripted messaging, but may be biased towards standalone operation (no requirement for app 329), single button functionality (one plastic button on device 101 will send one pre-scripted SOS message), and/or integral coupling with location services (sending an SOS message will also send current GPS coordinates of the device 101). When the SOS functionality is initiated, the SOS message and optionally GPS coordinates are written as a digital packet and passed to the active components of the device 101.

Embodiments of the disclosure also provide for location sharing, optionally as a single standalone feature, which may be initiated by a user, by an automatic schedule (e.g., for fleet or tactical uses), or in response to a ping or query from a server system 315 or second device 102. For location sharing, a GPS unit provides GPS coordinates to an MCU which encodes those as a digital packet for transmission over a designated band of frequency such as the L-Band. In the various embodiments, once a message is packaged as a digital packet, the downstream functionality is the same regardless of the communication type.

In general, the controller unit (e.g., MCU) represents the message as a digital packet, wherein the digital packet encodes about 50 to 500 characters of message data or about 0.1 to 10 seconds of voice per packet. The transceiver unit transmits the digital packet to the satellite within about 120 ms.

When the app 329 is used, the device 101 receives the digital packet via a PAN connection (e.g., BLE) and generates, using a modulation technique such as chirp spread spectrum modulation, phase shift keying, and amplitude shift keying an RF signal that contains the digital packet. The device 101 sends the RF signal via the designated band of frequency to the satellite. With reference to the system 301, the satellite 312 may send the RF signal to the satellite ground station 306. The transceiver array 307 relays the digital packet to the server system 315.

While systems of the invention may use various components in various combinations, the depicted transceiver array 307 is one important component to mediate communications between the extrinsic network of satellites 312 and the integral central server system 315. The network of satellites 312 typically uses at least one satellite ground station 306. The system 301 of the invention preferably uses the server system 315. The server system 315 may use one or any number of “server computers”, e.g., rack-mounted servers or other networked computer units. Those server computers may be communicatively coupled together within one “server room” or across one or more “server farms” or data centers. Those server computers may be provided in whole or in part as a cloud computing system. Regardless of how those server computers are distributed (or not) or deployed, they are preferably administered by a system administrator using a front-end “terminal” (drawn to represent server system 315 in the system 301).

It is noted that any server computers and system administration terminal that make up the server system 315 (even if computing power is provided or supplemented by cloud resources that are only “spun up” on-demand) are all typically likely to be terrestrial, operating within some system facility 316 somewhere on or near a surface of the Earth. In that sense, a satellite ground station 306 is typically associated with a satellite facility 318, often under control of the same entity that controls the network of satellites 312. The satellite ground facility 318 may have a building linked to, or a campus encompassing, one or more terrestrial satellite antennas 305. In generally, the satellite facility 318 and the system facility 316 will both be principally terrestrial, i.e., both located at a location on Earth. Preferred embodiments of the system 301 have the transceiver array 307 communicatively positioned between the server system 315 and a satellite ground station 306. Notably, embodiments of the invention are provided in which the transceiver array 307 is located at the system facility 316. Other embodiments of the invention are provided in which the transceiver array 307 is located at the satellite facility 318 (preferably coupled to a local hub computer, which is also located at the satellite facility 318.

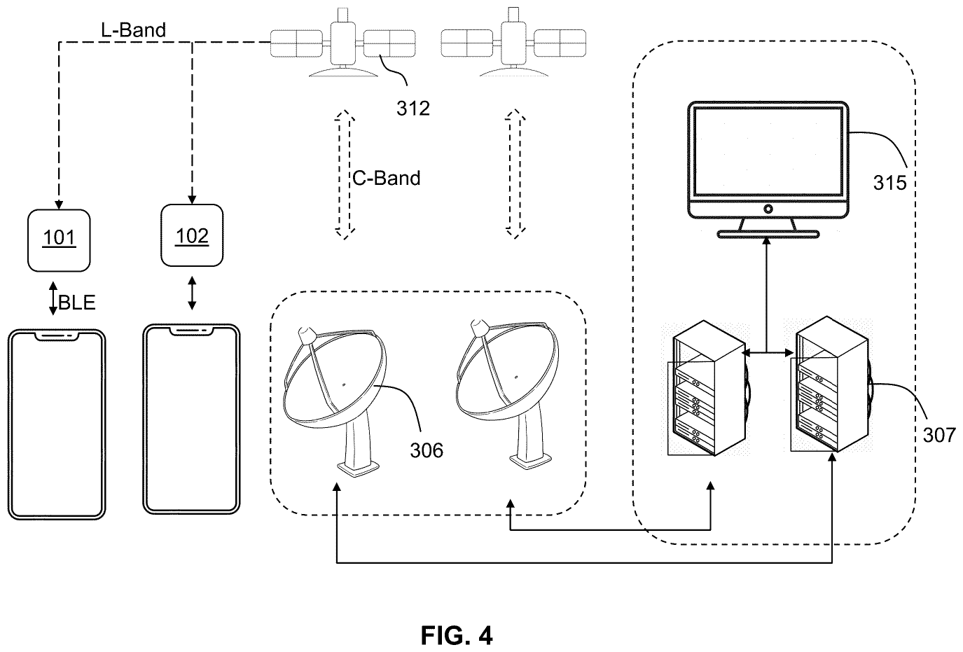

FIG. 4 diagrams elements of a system wherein the transceiver array 307 is located at the system facility 316. In any of the various embodiments, the base station (e.g., server system 315) may route the message based on an online location and network availability database. This database determines whether an app paired with destination device 102 is online in a cellular network. If online, the message is sent via the cellular network. If offline, the router verifies the location of the destination device 102, ensuring that the sending frequency aligns with its location.

Whether the array 307 is located at satellite ground facility 318 or system facility 316, the server system 315 is operable to perform a method that includes receiving, by the transceiver array 307 communicatively coupled to a satellite ground station 306, a modulated signal (e.g., ASK, PSK, CSS) from a satellite 312, demodulating the signal into a digital packet; and sending the digital packet via internet protocol (IP) from the transceiver array 307 to the server system 315. The server system 315 hosts the identities of a plurality of satellite communication devices 101, 102 and reads an identity of a recipient device 102 from the packet. Note that at this stage, the communication is the digital packet, not an RF waveform. Once the server system 315 identifies the recipient device 102, the server system 315 operates the transceiver array 307 to modulate the digital packet onto a carrier wave and send the modulated waveform as a signal encoding the packet to the recipient device 102 via the satellite 312.

In the version shown in FIG. 4, the transceiver array 307 shares a geographical site with the server system 315 and communicates with the satellite ground station 306 via internet protocol (IP).

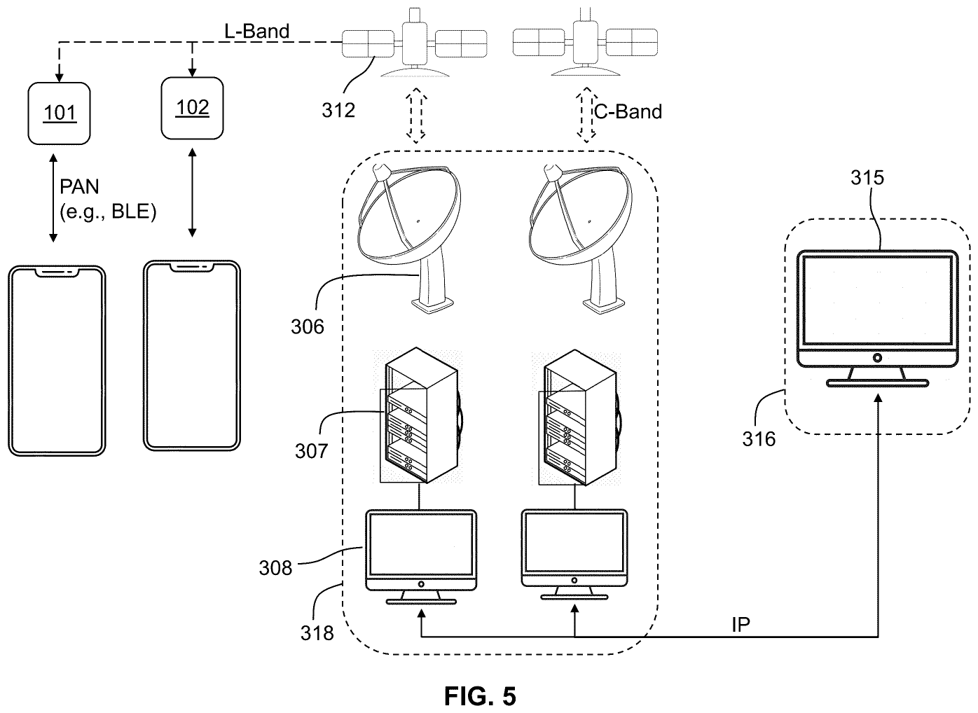

FIG. 5 illustrates an embodiment in which the transceiver array 307 shares a geographical satellite site 318 with the satellite ground station 306 and with a local hub computer 308. The transceiver array 307 sends the digital packet to the local hub computer 307 at the satellite site 318. The local hub computer 308 communicates with the server system 315 via IP. As shown, the transceiver array 307 is located at the satellite facility 318 shown being coupled to a local hub computer 308, such that the transceiver array 307 and the local hub computer 308—which are provided or controlled by the administrator of the server system 315, where the server system 315 is typically located at the system facility 316. As show, the hub (the transceiver array 307 and the local hub computer 308) may be geographically located at the satellite facility 318. However, the hub is not typically an integral part of network of satellites 312 and the satellite ground station 306 (which collectively may be provided as a collective resource by a satellite communications firm such as IMMARSAT (London, UK). Instead, the hub may operate within the satellite facility 318 under control of the server system 315 of the system 301. As shown, the hub comprises at least ground-based transceiver array 207 coupled to a local hub computer 308. The hub mediates the relay of a transmission from device 101, through a satellite 312, to a second device 102 (e.g., optionally using a first channel on a satellite beam for the first device and a second channel on the satellite beam or the second device).

Certain diagrams omit any cellular networks to aid in understanding the satellite components of the communications. However, it is important to describe and understand that cellular networks form an important part of communication systems and methods of the invention.

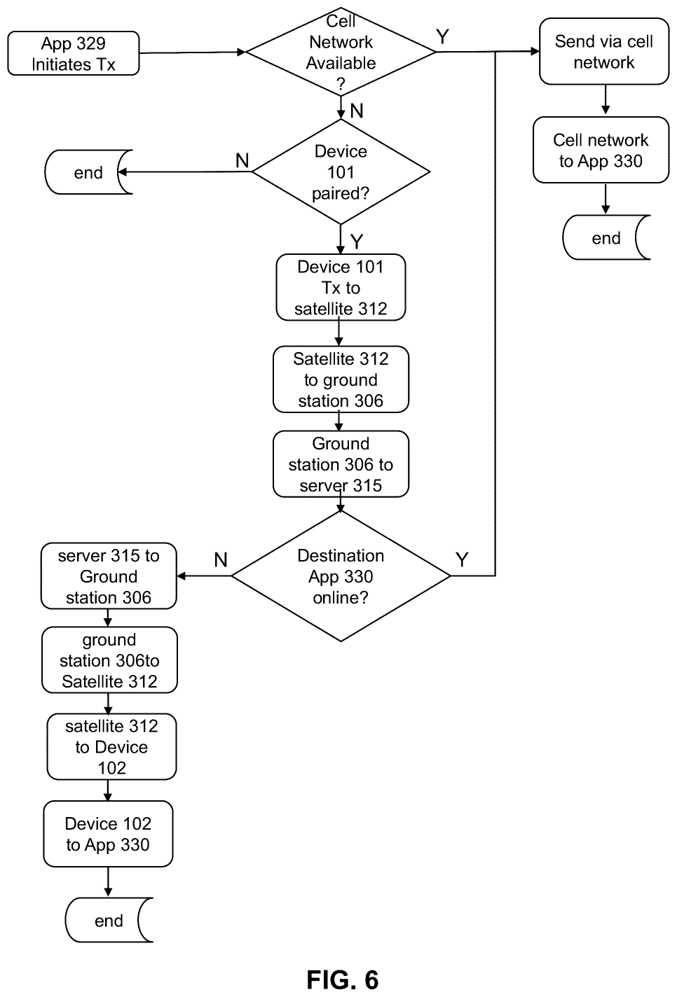

FIG. 6 diagrams how the system 301 will route a message depending on availability of components of the system, to a destination app 330. As shown, a user may use an app 329 to initiate transmission of a message from a smartphone or other local computing device to a second device 102. The app 329 writes the text message as a digital packet and determines if a cell network is available. If cell service is available, the app 329 sends via cell. If no cell network is available, the app 329 determines whether a device 101 is paired. If the device 101 is paired, the app 329 sends the digital packet via a personal area network (PAN) connection to the device 101. The device 101 transmits the modulated waveform to a satellite 310, which sends the signal to a ground station 306 from where the signal is demodulated and the packet is sent to the server system 315. If the destination app is online (e.g., within a cell network), the packet is sent via the cell network. If the destination app 330 is not online, then: the server 315 sends the packet to via ground station 306 to the satellite 312. (A transceiver array 307 between the ground station 306 and the satellite 312 encodes the packet as a signal on a modulated waveform.) The satellite 312 send the signal to the device 102, which passes the packet to the app 330.

That functionality involves the use of a device 101 and paired app 329 by one user to perform one embodiment of a method of the invention.

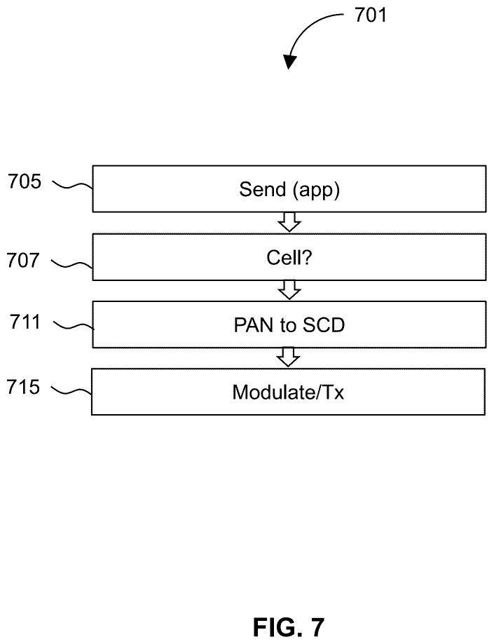

FIG. 7 diagrams steps of a communication method 701. The method 701 includes using an app 329 on a local computing device (e.g., smartphone) to initiate sending 705 a message to a recipient. It may appear that the preceding flowchart and the diagram of the method 701 refer to the same functionality. However, the flowchart is presented to illustrate the roles of various terrestrial and celestial devices while the method 701 is shown to draw attention to how one connected device (a device 101 paired with an e.g., smartphone) operates to perform communication using cellular and satellite systems. The user (a “sender” of a message) uses an app 329 to compose or initiate sending a message. The app 329 determines 707 whether a cellular network is available. When the cellular network is not available, the app 329 sends 711 the message as a digital packet by a personal area network (PAN) connection to a device 101 paired with the phone. The device comprises a controller unit coupled to a transceiver unit. The controller unit generally controls operations of the transceiver unit. The method 701 further includes modulating 715 (via the transceiver unit) the digital packet onto a carrier wave and transmitting the wave via an antenna of the transceiver unit to a satellite over a designated band of spectrum. The modulation technique may be any suitable modulation such as PSK, ASK, or CSS. The designated band may be the L, S, C, X, Ku, Ka, Q, or V Band or similar. In preferred embodiments, the modulation technique is one that is used for Internet-of-Things (IoT) functionality, but then sent within a channel within an L-band to a satellite such as a GEO satellite.

The user may select a message recipient using the mobile app 329. The method 701 may include encoding, by the mobile app 329, the recipient into the digital packet and identifying, by a connected server system 315, that the recipient is a registered user. In certain embodiments, the server system 315 routes the message to the recipient. For example, the server system 315 may (as a result of the send 705 operation by the user) determine a location of the recipient (e.g., by pinging destination device 102), identify a beam and/or channel of a satellite available to the recipient; and use a transceiver array 307 to send the message to the satellite 312 for routing to the device 102 of the recipient. When the server system 315 determines that a cellular connection is available to the recipient, the server system may send the message via the cellular connection to a recipient smartphone or similar such device.

In the method 701, the user device 101 may select a channel and beam of the satellite based on instructions previously received from the server system 315 or based on its own GPS data and data stored therein. For example, the device 101 may maintain a database representing geographical extent of beams of the satellite 312 as polygons. The device 101 may operate to change which beam and/or channel the device 101 is using by using a global positioning system (GPS) coupled to a controller unit within the device 101. The controller unit is operable to obtain coordinates for a current location of the device from the GPS and select from the polygons an active polygon representing a satellite beam available to the device. Moreover, the app 329 may determine when a cellular network becomes available to the smartphone and to send via the cellular network when the cellular network is available.

By method 701, the user may use app 329 to send a voice or text message from the smartphone to a recipient. The app may communicated to the device 101 by a personal area network (PAN) connection, preferably a Bluetooth low energy (BLE) connection. The mobile app 329 may write the message as a digital packet and sends the digital packet to the device 101 via the BLE connection. Once the device 101 receives the digital packet via the BLE connection, the device may generates, using chirp spread spectrum modulation or other suitable modulation by the transceiver unit, an RF signal that contains the digital packet modulated onto the carrier wave as a chirp spread spectrum waveform and sends the RF signal via a designated band such as the L-Band to the satellite.

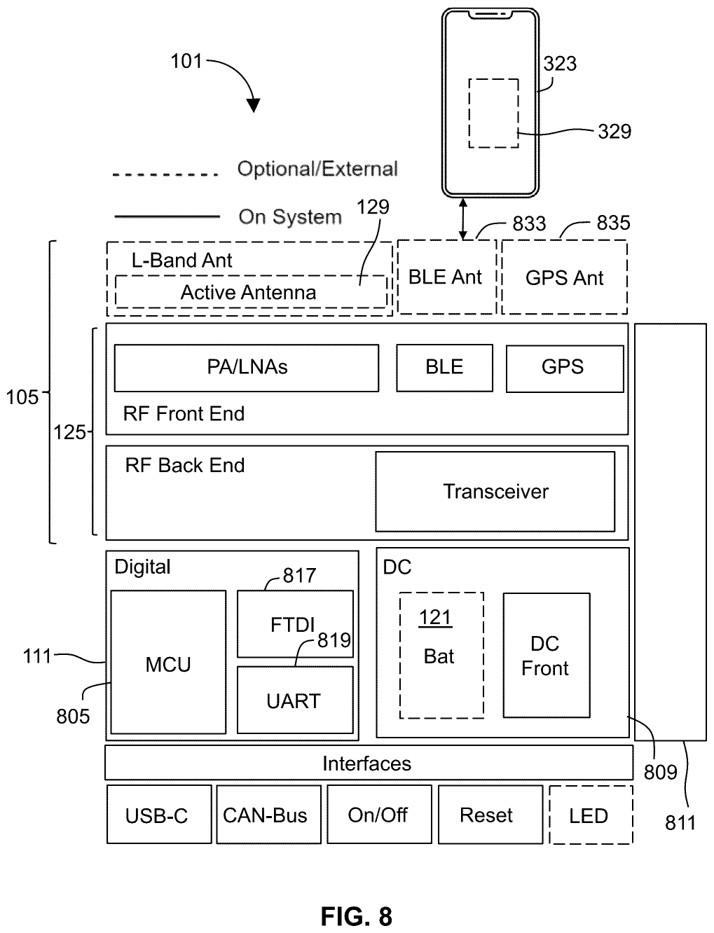

FIG. 8 is a block diagram of components of a satellite communication device 101. The device preferably has a PCBA 111 connected the transceiver unit 105. The transceiver unit 105 includes an antenna printed circuit board (antenna PCB) 125 operably connected to the PCBA 111. The device includes a power supply 805, which may be an on-device battery 121 or may be a hardware connection, such as a port or jack, for connection to a power source. In certain standalone device embodiments, the device 101 includes the battery 121, an antenna 129, a PAN connection antenna 833, and/or a GPS antenna 835. In other embodiments, such as for fleet communication, the device 101 may be installed on a vehicle any one or more of the battery 121, the antenna 129, the PAN connection antenna 833, and/or the GPS antenna 835 may be outside of (e.g., separate from) the device 101 and may be connected to the device via one or more jacks, ports, or interfaces.

A controller unit 805, such as a microcontroller unit (MCU), is provided on the PCBA 111. The PCBA may include a converter module 817 and a universal asynchronous receiver-transmitter (UART) 819 for data transmission to/from the MCU 805. The device 101 includes wireless interface hardware 811 for providing, for example, a personal area network (PAN) connection. Preferably, the interface hardware 809 uses an antenna to communicate with a local computing device 323, which preferably has therein app 329. In the depicted embodiment, the local computing device 323 is a smartphone connected via a Bluetooth low energy (BLE) antenna. The controller unit 805 may receive—from app 329—content as a digital packet that includes at least source, destination, metadata and payload data. The transceiver unit 105 encodes and encrypts the digital packet and sends the message to a satellite within the designated band.

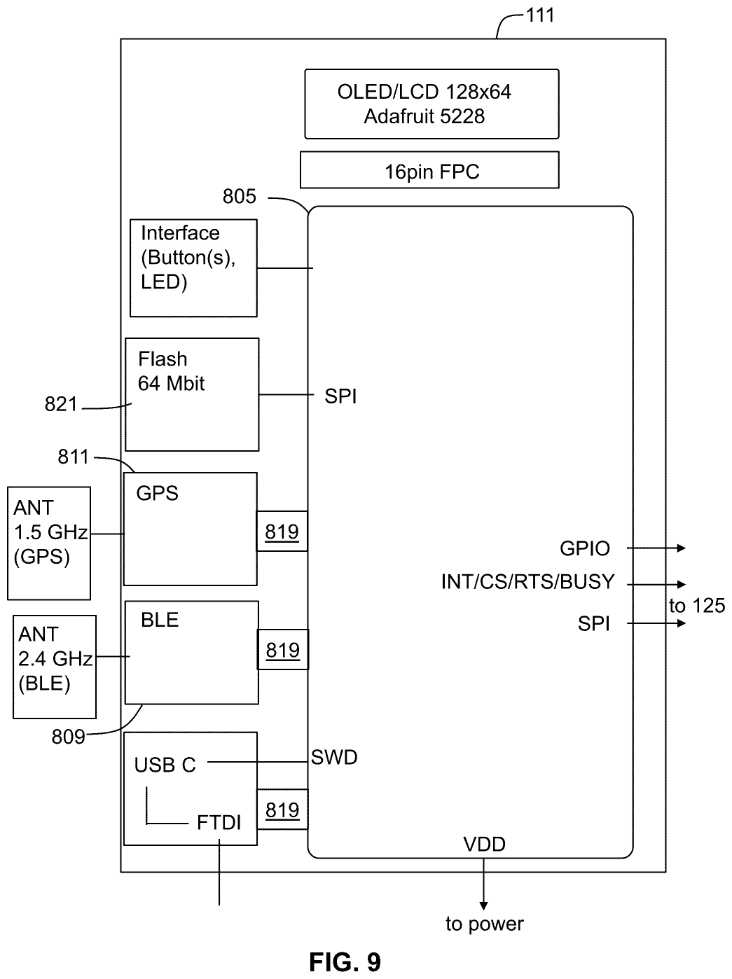

FIG. 9 is a block diagram of elements that may be included with the PCBA 111. The MCU 805 may be connected via the PCBA 111 to one or more of a universal asynchronous receiver-transmitter (UART) 819. Other components maybe connected to the MCU 805 by a serial peripheral interface (SPI), which is understood in the art and does not need to be drawn on the diagram. As shown, the PCBA may include a memory subsystem 821 and a global positioning system (GPS) 811 coupled to the controller unit 805. The microcontroller unit 805 may use coordinates from the GPS 811 and data stored in the memory subsystem 821 to identify a beam of the satellite that is available for communication between the device and the satellite.

In preferred embodiments, the controller unit implements a frequency changing algorithm to set a transmission (Tx) and/or a reception (Rx) frequency based on a frequency indicated as available from the server system 315 or an internal data base stored and pre-configured in the device.

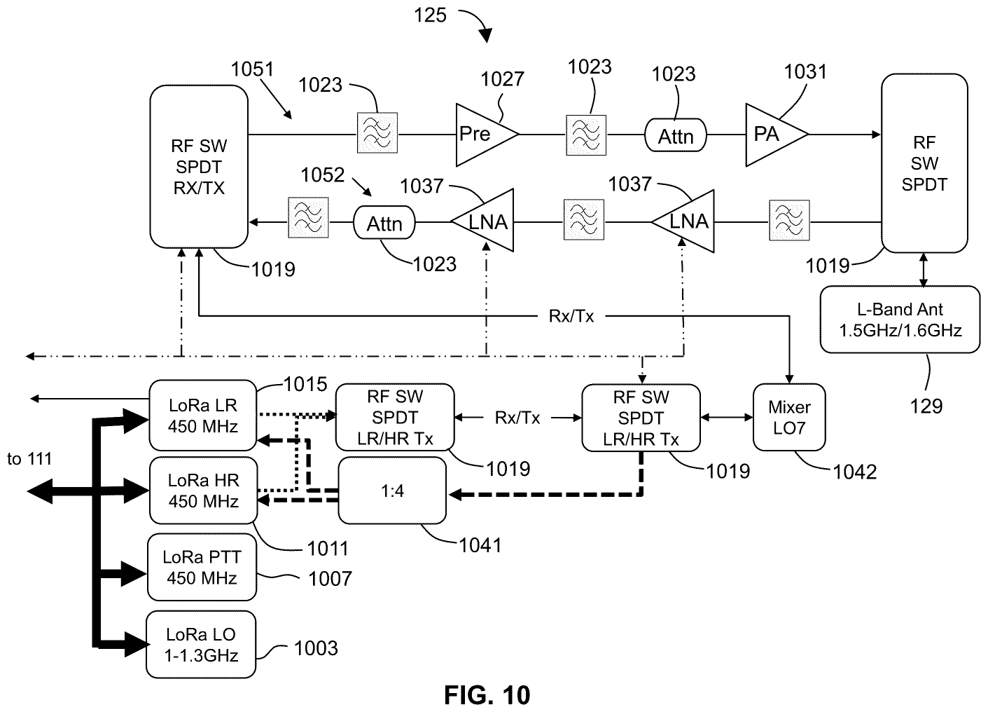

FIG. 10 is a block diagram of elements that may be included with the transceiver unit 105. The transceiver unit 105 preferably includes an antenna printed circuit board (antenna PCB) 125 operably connected to an antenna 129. A digital packet is sent from the PCBA 111 (e.g., via an SPI on PCBA 111) to the antenna PCB 125 where it is passed to one of multiple independently-operable transceiver sub-units 1015, 1011, 1007, 1003.

In the depicted embodiment, the LoRa transceiver(s) and the antenna are connected via at least a transmit section 1051 and a receive section 1052. As shown, the antenna PCB 125 includes a high-rate general purpose transceiver subunit 1011, a high-rate push-to-talk (PTT) transceiver subunit 1007, and a low rate general purpose transceiver subunit 1015. One or more additional transceiver subunit 1003 may be included. A transceiver subunit 1015, 1011, 1007 will generally modulate a carrier wave with the packet into a signal waveform that will get passed along to the antenna 129. Elements of the antenna PCB 125 connect via switches 1019. The antenna PCB 125 may include one or any number of multiplexer 1041 and/or mixer 2042. The antenna PCB 125 preferably includes a transmit section 1051 and a receive section 1052. The transmit section 1051 and the receive section 1052 may each include one or any combination band pass filter 1023, pre-amplifier 1027, attenuator 1023, power amplifier 1031, and low-noise amplifier 1037. For example, those elements may be provided and arranged as shown, or as would be understood by one of skill in the art as suited to the invention.

As mentioned, a transceiver subunit 1015, 1011, 1007 will generally modulate a carrier wave with the packet into a signal waveform. Any suitable waveform may be used.

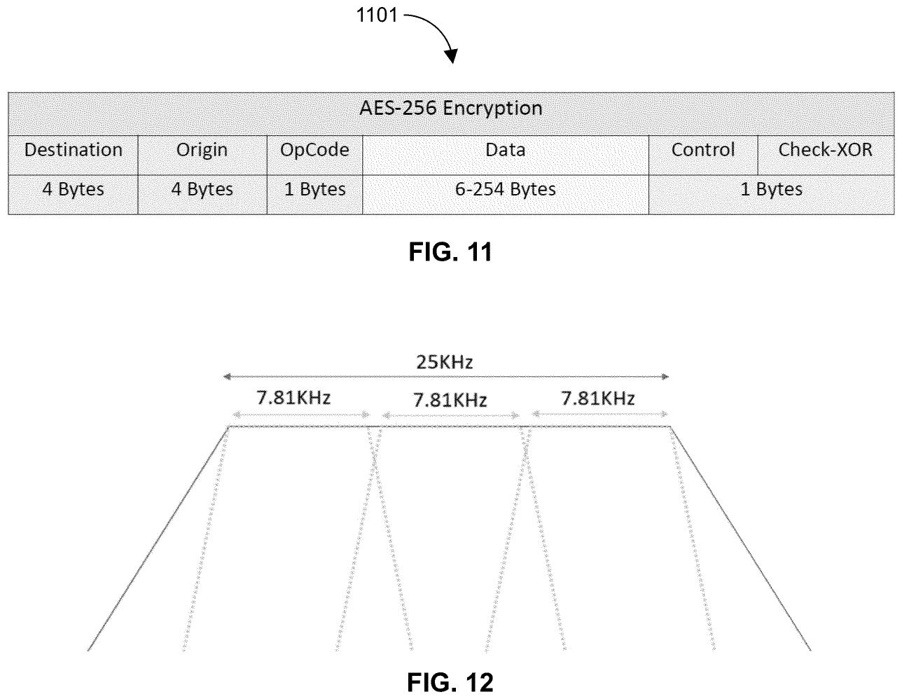

FIG. 11 diagrams elements of a digital packet 1101 that may be sent or received by systems and devices of the invention. The components, byte allocation, and encryption indicated for packet 1101 are exemplary only and the skilled artisan may include or excludes components or allocate different numbers of bytes. Generally, the packet begins with destination and origin encoded and further includes an operation code, a payload, and a checksum. The packet 1101 may be any suitable size including, e.g., 8 bytes, 16 bytes, 96 bytes, 264 bytes, etc. The design of the digital packet 1101 accounts for certain critical factors: (1) size (e.g., 16-96 bytes for a message packet or any arbitrary number of bytes for a voice packet; (2) structure (flexible, but as illustrated includes [4B Destination] [4B Source] [(arbitrary number of bytes) Control] [13-93B Payload] [checksum]]; and (3) security. The packet may be encrypted by a suitable encryption schema such as a block cipher or other such military grade encryption. Certain embodiments use an advanced encryption standard (AES) such as AES-256 encryption as described in the ISO/IEC 18033-3 standard, incorporated by reference. When the destination and origin blocks each have 4 bytes, those blocks provide approximately 4 billion unique addresses, covering the user capacity of the system. The packet design and size, modulation waveform (e.g., CSS, ASK, or PSK) and encryption provide the effectiveness, security, and adaptability of the digital packet 1101 for diverse communication needs. The packet 1101 is modulated onto a carrier wave at the antenna PCB 125.

Any suitable modulation technique may be used. Various embodiments use one or a combination of phase shift keying (PSK), amplitude shift keying (ASK), frequency shift keying (FSK) or spread spectrum modulation. Preferred embodiments use a modulation technique that has been implemented for internet-of-things (IoT) device. IoT modulation techniques have included spread spectrum modulation and, in particular, chirp spread spectrum (CSS) modulation. Certain preferred embodiments of the invention use CSS modulation and may specifically use the version of CSS modulation standardized as the LoRa (from “long range”) standard. The carrier waveform having been modulated with the packet 1101 is here referred to as a signal. Using antenna PCB 125, the device 101 then sends a signal via e.g., L-band encoding the packet 1101. The device 101 (or a transceiver array) sends (or receives) the signal within a channel provided by a beam of a satellite. In fact, using the modulated waveform, the signal occupies less bandwidth than a channel of a satellite, and a device of the invention may send/receive multiple signals simultaneously within a channel.

In practical use, the signal (comprising the packet 1101 modulated onto the waveform) is essentially broadcast to components of the system 301. A device 101 sends the packet which is intended for a recipient device 102 which is registered on the server 315 by a user ID that is now encoded in the packet 1101. The intended recipient may be a group of individuals (or devices) and the destination block of the packet 1101 may be a group ID. The server 315 may manage group membership. The device 101 broadcasts the signal. The signal may go via the server 315, allowing the server 315 to specifically pass the signal along only when the intended recipient is available. However, the signal may never be processed by the server system 315, instead being passed directly to recipient device 102 by a satellite 312 operating as a bent-pipe. In such a case, the recipient device reads the destination block for its own user ID or encompassing group ID and only processes the receipt of the signal when the device 102 is indicated as an intended recipient.

As mentioned above, the digital packet 1101 is modulated onto a carrier wave by a modulation technique preferably such as is used for IoT communication. For example, the LoRa standard is implemented by a variety of commercially available chips that may be used in the device 101. When a modulation technique such as LoRa or a similar chirp spread spectrum is used on the packet 1101 and the modulated signal is converted into the designated band, e.g., the L-Band, the modulated signal will use less than about 8 KHz of spectrum, and even significantly less depending on specifics of compressing, modulation, packet size, etc.

FIG. 12 illustrates how several signals with about 7.8 KHz of spectrum may simultaneously occupy a satellite channel with about 25 KHz of spectrum. In the illustrated embodiment, three signals may be handled simultaneously. However, using an IoT modulation protocol for channels of a geostationary satellite (or another similar combination of satellite network and modulation waveform), a larger number (e.g., 12) of signals may be simultaneously sent within one channel. That is, using for example, a chirp spread spectrum waveform, one signal may use a bandwidth less than about a third, even less than about 1/12, of a satellite channel bandwidth. Preferably, the chirp spread spectrum waveform conforms to the LoRa standard or another defined standard for “internet-of-things” (IoT) communication.

Employing a CSS (e.g., LoRa) transceiver alongside the controller unit, the device 101 achieves a narrow bandwidth of 7.81 KHz or lower. The bandwidth allows multiple users to efficiently utilize a standard 25 KHz satellite channel. In a full 25 KHz channel, the system can concurrently transmit three (3) 250-character messages or 1 second of voice via a single beam. Each message occupies the channel for approximately 240 ms (120 ms device to satellite and 120 ms satellite to Earth), resulting in a capacity for over 250,000 messages per day per channel. Using just four channels, over IM messages can be send in a day, making the device 101 useful or high-throughput, distributed communication (e.g., multiple of device 101 distributed among numerous personnel, vehicles, or sites).

Devices of the invention are operable to communicate via a specific channel of a specific beam of a satellite and to hop from one beam to another when a device changes beam availability (based on, e.g., the device moving over the Earth). The device 101 uses a GPS unit 811 and polygon data stored in memory to perform the beam hopping.

Preferably, a device 101 and/or a server system 315 has stored therein data representing geographical coverage of each beam of a satellite 312. Using the Inmarsat geostationary satellites as an example, each of about three satellite has an antenna that covers about a third of the Earth via a set of beams, each subtended by space on the surface that can be reasonably represented by a polygon. The device 101 and/or server system 315 represents those polygons as a set of geometry files that can be mapped to GPS coordinates. The device 101 includes a GPS unit 811 that provides the device 101 with its current GPS coordinates. The controller unit 109 is operable to compare the current GPS coordinates to the geometry files to determine an available beam of the satellite 312.

In certain embodiments, the device 101 performs a beam check operation every few (e.g., 10) seconds. Such timing is suitable because if the device is on a plane flying at 1000 km/h, in 10 seconds it will move approximately 3 km (within beam overlap). The beam check operation is preferably quick, allowing the MCU to be set to sleep most of the time to minimize power use. For the beam check, noting that location is measured in degrees on Earth, the MCU may convert degrees of latitude and longitude to surface distance (e.g., at zero degrees latitude, the size of one degree of longitude is 111 km, but at 70 degrees latitude, the size of one degree of longitude is 38 km). Preferably, the device uses flash memory (with data such as polygons saved therein), an MCU with an FPU (floating-point unit), and GPS. The data in memory represents satellite beam coverage as polygons on the Earth's surface. The device 101 checks if its current location is in a different part from the last time it checked. If the device has entered a new polygon, the device can change its beam. In one example, each polygon is represented in memory as vectors written in an anti-clockwise direction. When the device 101 is first turned on and at every interval (e.g., 10 s), the device 101 may run through every polygon and save the maximum and minimum values of latitude and longitude. Then it will save this information to flash memory to be used in a “point in polygon” (PIP) algorithm. In the PIP algorithm, the device 101 may run through all the polygons and use the PIP algorithm to find which polygon includes the location.

The device 101 can check if a given point (e.g., its current GPS coordinates) is inside of the polygon by moving from line to line along the border of the polygon in anti-clockwise and check if the point is on the left of the line, if it is always yes (on the left), the device is inside of that polygon. By such means, the device is able to determine which beam of a satellite is presently available to the device.

The controller unit 109 also determines an available channel of the beam (e.g., by querying the server system 315). Thus when the controller unit 109 write the packet 1101, the controller unit 109 may also provide the transceiver unit 105 with information about the available channel, allowing the transceiver unit to send/receive within that channel.

A number of specific operating modes are within the scope of the disclosure.

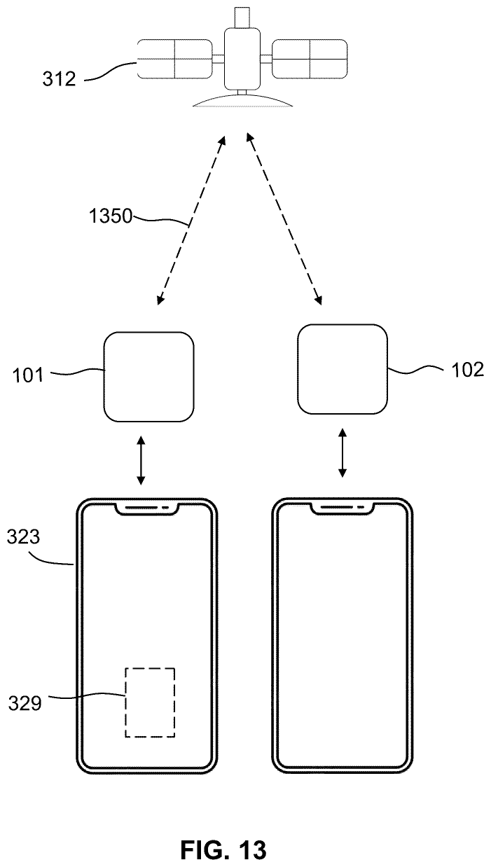

FIG. 13 illustrates a device 101 communicating with a recipient device 102 via a designated band of frequency such as the L-Band 1350 and satellite 312 without any hub computer. The local computing device 323 has an app 329 by which a user may send and receive messages. As shown, the one device 101 performs CSS (e.g., LoRa) modulation on a digital packet that includes bits identifying the second device 102 and sends the modulated digital packet via the designated band to the satellite 312. The satellite 312 performs a bent-pipe return to pass the modulated digital packet via the designated band to the second device 102. The second device 102 reads the bits identifying the second device and passes the digital packet via a PAN connection to a second smartphone.

In some embodiments, devices 101, 102 communicate via a hub computer without needing or reaching a satellite ground station 306 or the server system 315.

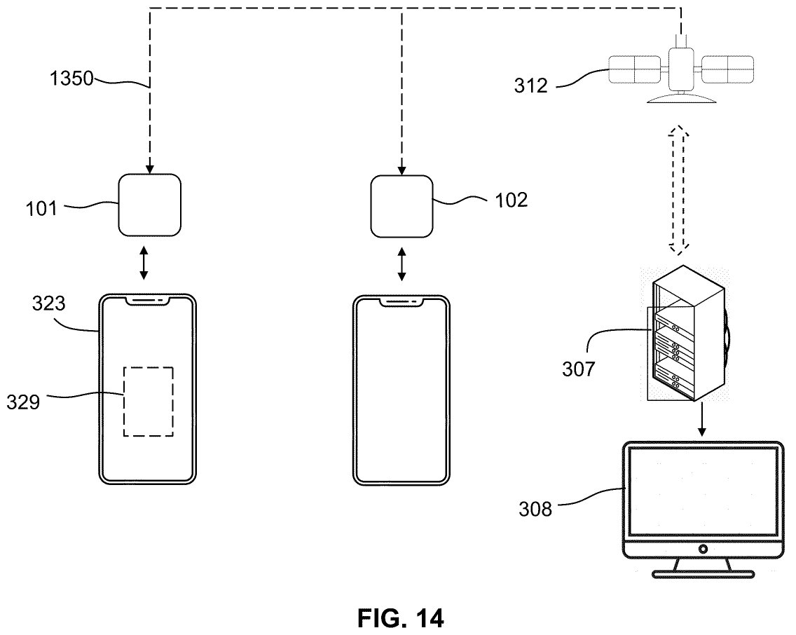

FIG. 14 shows an embodiment in which device 101 communicates with device 102 through satellite 312 as mediated by hub computer 308 using a transceiver array 307. The hub computer 308 and its transceiver array 307 may collectively be referred to as a hub, and—whether or not the system 301 includes a server computer—the hub may be installed at some site to augment connectivity. The hub mediates the relay of a transmission from device 101, through a satellite 312, to a second device 102 (e.g., optionally using a first channel on a satellite beam for the first device and a second channel on the satellite beam or the second device). Specifically, the hub may demodulate the transmission to read a digital packet. A header of the packet identifies the second device 102 as an intended recipient. The hub may verify, optionally using a database and/or GPS on the second device, a channel and/or beam of the satellite 312 available to the device 312. The hub computer 308 may manage availability of channels on the satellite 312, relaying a message to device 201 using an available channel. Preferably the hub communicates the transmission through operation of the transceiver array 307 to re-encode the packet via chirp spread spectrum modulation, phase shift keying, frequency shift keying, or amplitude shift keying modulation and sending to the satellite 312.

Thus the diagram illustrates a method that includes receiving, by a hub, a message comprising chirp spread spectrum modulated digital packet from a satellite 312. The hub includes at least a ground-based transceiver device or array 307 (only one transceiver need be included) coupled to a local hub computer 308. As shown, the hub is remote from any satellite ground station. This embodiment of the method includes identifying, by the local hub computer 308, a recipient second device 102 for the message based on bits in the message; and controlling the ground-based transceiver device or array 307 by the local hub computer to send the message to the satellite 312 to be relayed, by bent-pipe operation of the satellite, to the second device 102.

With reference to the system 301, attention is now brought to the app 329 provided on a local computing device 323, such as a smartphone, to provide certain functionality.

The app 329 is software that a user may install or access on his or her own computing device. The app 329 provides various functions including allowing the user to register with the system, manage contacts, manage group membership, send and receive short written message, send and receive voice messages, send and receive location data, send and receive certain pre-scripted messages including “SOS” message, identify a current location of a connected device 101, or identify location of a second device 102. The app 329 can provide a user with certain screens or views for interacting with the device 101. For example, the app 329 may provide an interface, or screen, for Configuration-configuration screen including the Billing, Contacts and etc.

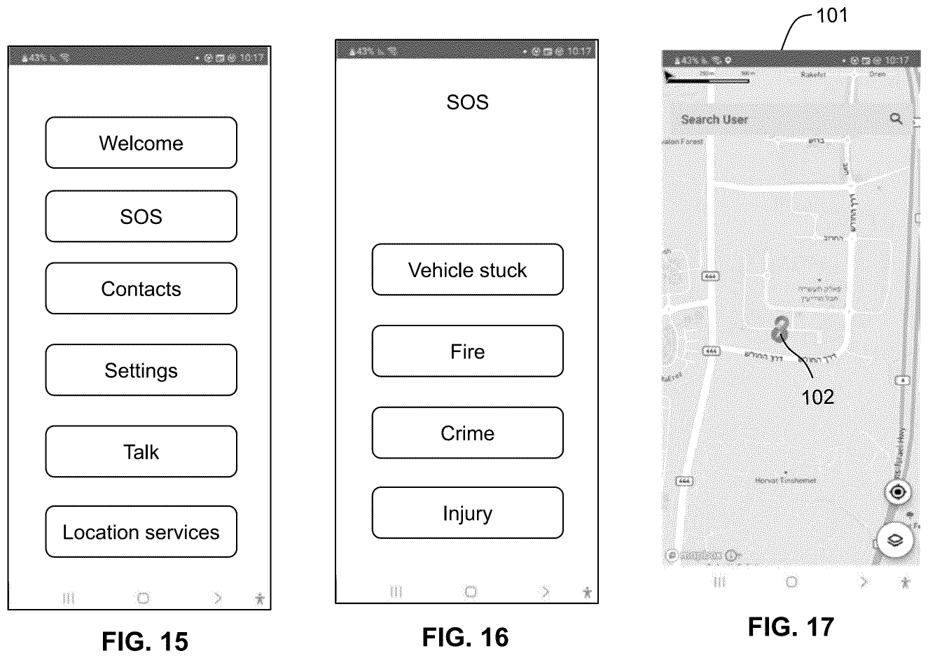

FIG. 15 illustrates a home screen of the app 329 and buttons to invoke certain functionality offered by the app 219 and the device 101. From the home screen, a user may touch buttons to invoice functionality for sending an emergency message (SOS), managing contacts, adjusting app settings, speaking (PTT), and location sharing. For example, the home screen may have a button for push-to-talk, allowing the user to begin a mode by which, as the user depresses a button the computing device 323 (on screen or hardware button on device), the user speaks and the app records the sound as the digital packet 1101, then invoking the transmission functionality described herein.

FIG. 16 illustrates a screen of app 329 by which a user may send a pre-defined SOS message as a packet 1101 via a satellite 213 or a cellular network. Note that, as shown, the app offers certain pre-scripted messages. Those messages are preferably stored within the app, but my also or alternatively be stored on the device 101 Sending an SOS message may optionally come with automatic location sharing, sending the user's GPS coordinates. Separately from SOS messages, the app 329 may provide an interface, or screen, for location sharing-shows a real-time location. Location sharing may have self-evident emergency or crisis-management applications (“send help to this location”) but also may provide valuable utility in numerous other scenarios. Location sharing may lie at the heart of fleet management, allowing a system administrator to view locations of numerous vehicles. Location sharing may be a critical part of research or recreational exploration (“our group is at this location”). Noting that communications are subject to military grade encryption, location sharing may have key tactical value allowing, for example, a user to silently send only to an intended recipient a notice of, e.g., successful arrival.

FIG. 17 shows a screen presented by app 319 by which a user of computing device 323 and connected device 101 may find a second user of second device 102. While the image is oriented as if seen on a smartphone, the image also represents how a system administrator, using the server computer 315, may view users and their locations. As shown, an individual using the device 101 may view, on-screen, the instantaneous locations of other devices 102 that are registered or sharing within the same system or group.

Note that cellular networks form an important part of communication systems and methods of the invention. In addition to described satellite communication, when paired with a local computing device such as a smartphone and when a cellular network is available, the device 101 can also communicate via the network to enhance satellite availability, especially when alternative communication methods like cellular networks can be utilized. Cellular availability is leveraged not only for communication but also for satellite beam hopping when the device 101 enters a new beam area, further expanding the accessibility of the satellite beam.

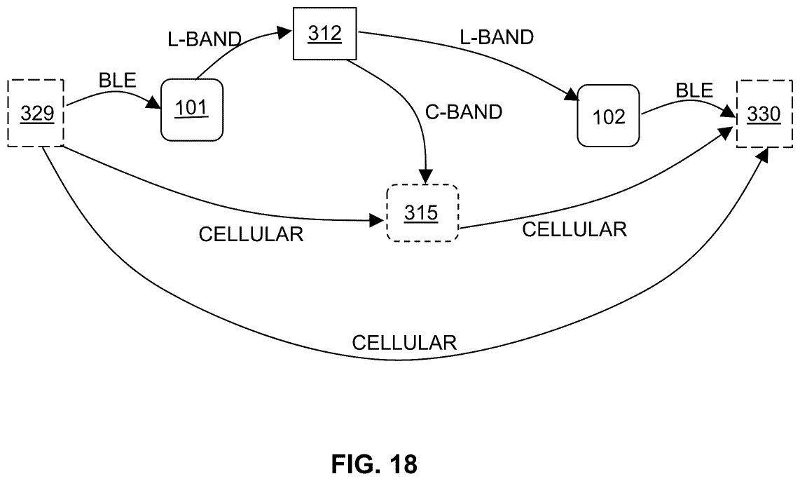

FIG. 18 shows communication paths via which a user using app 329 may send a communication to a second user using a second app 330. As shown, the app 329 may send the communication to the device 101 via a PAN connection such as a Bluetooth low energy (BLE) connection. Also, the app 329 may send the communication via cellular networks to server system 315 or to the second app 330. If the communication is sent to the device 101, the device 101 send the communication via an L-Band to satellite 312. The satellite 312 may simply send the communication via L-band to second device 102. The satellite 312 may also send the communication to server system 315, e.g., via C-Band. For clarity, these lines are not shown, but the server system 315 may send the communication back to a satellite, which pass the communication to the second device 102. Separately, the server system 315 may use a cellular network to send the communication to the second app 330. If the satellite sends the communication to the second device 102, the second device will use a BLE connection to send the communication to the second app 330. Notably, starting with app 329, a digital packet 1101 may be sent to app 330 along any depicted path. Paths labeled “cellular” generally may involve data transfer over cellular networks and/or internet protocols. Paths labeled “BLE” may refer to any personal area network (PAN) connection such as a Bluetooth low energy connection, a near field connection, a Bluetooth connection, or even a wired connection (e.g., USB). Paths labeled L-Band or C-Band generally refer to the indicated band of spectrum on which a satellite communicates and by which the digital packet is modulated on to a waveform, e.g., by chirp spread spectrum modulation such as LoRa, and sent/received using an antenna.

Along any of the indicated pathways, a component of a system 301 that receives a signal (at an arrowhead) may send an acknowledgement back any distance along the sending path to any component of the system 301 that was upstream along the path. The technical features of an acknowledgement may be the same as message sending described herein throughout; a digital packet containing the acknowledgment may be modulated onto a waveform and also sent along any of the indicated paths, when available.

Message acknowledgements occur along critical paths in the described process. Message acknowledgements may be programmed into the device 101, 102 and/or the server computer 315 and may be sent automatically to the sender or the server, as desired by an administrator of the system.

The following process step cover two important scenarios by which systems and methods of the invention operate, scenario A and scenario B.

In scenario A, a device 101 paired with app 329 sends to device 102 paired with app 330 when no cellular network is available. Tracing paths across the upper portion of FIG. 18, scenario A may involve any of the following process steps:
1. Source Local: The app 329 sends a message via local PAN connection (Text, Voice or Location) to device 101;
2. Source Uplink: The device 101 sends the message to the satellite 312 within an L-band, knowing its pre-defined beam and frequency, using an IoT modulation;
3. Downlink: The satellite 312 transmits the message to a stationary server 315 based base station (converting back to packet via a transceiver array 307 (not pictured);
4. The base-station server system 325 routes the message back to the satellite, addressing it to destination device 102;
5. Uplink: The base-station uploads the message to the satellite 312;
6. Destination Downlink: The satellite 312 transmits the message to the destination device 102; and
7. Destination Local: The device 102 sends the message via PAN connection (e.g., BLE) to the destination app 330.

In scenario B, a device 101 paired with App 329 sends to device 102 paired with app 330 when a cellular network is available. Tracing paths across the lower portion of FIG. 18, scenario B may involve any of the following process steps:
1. Source Local: Source The app 329 sends a message via local PAN connection (Text, Voice or Location) to device 101;
2. Source Uplink: Source The device 101, knowing an available beam and frequency band of the satellite 312, sends the message using IoT modulation within the L-Band to the satellite 312;
3. Downlink: The satellite 312 transmits the message to a stationary server system 315 (via transceiver array 307);
4. The server system 315 routes the message to the cellular network via IP, addressing it to the app 330;
5. Uplink: The sever system 315 uploads the message to the cellular network;
6. Destination Downlink: The cellular network transmits the message to the destination app 330; and
7. Destination Local: Destination The destination app 330 receives the message.

It is very important to note that scenarios A and B are not alternative embodiments or different options. When the system 301 is in use, a large number (dozens or hundreds) of the devices 101 may all be communicating simultaneously. The devices may be dispersed across diverse locations (e.g., variously in Brazil, Mexico, Canada, Scotland, Israel, Egypt, at-sea, in a helicopter over the Mediterranean, in a boat in a harbor in Sri Lanka, etc.) Each device may be experiencing its own resource availability. Across the system 301, both scenario A and B are likely happening in multiple instances simultaneously. In fact, each depicted resource deployment (e.g., FIG. 3; FIG. 4; FIG. 5; FIG. 13; and FIG. 14) may be happening with some probability. A feature of the system is that the server system 315, the devices 101, any hub computer, and any transceiver hub 307 are designed to simply and immediately select and use an available path of communication. Beyond facilitating the nimble use of different available resources, the server system 305 may also implement other important functions.

The server system 315 provides certain back-end functionality. Except for standalone functionality in which device 101 sends a packet 1101 to device 102 via satellite 312, communication by devices 101, 102 are mediated by a base station, e.g., the server 315 or a hub computer. The base station optimizes and provides for: (1) Number of users occupying the Satellite beam; (2) Online registration procedure for new users; (3) Satellite to Web/Cellular routing procedure; (4) Billing and subscription procedure; (5) a world-wide database to facilitate global communication either via cellular or satellite. Under these examples, the server system 315 provides one important group management function.

Users or a system administrator may define certain groups within records in the server system 315. Typically, a group is given a group ID within the system 301 similar to how each registered user is given a user ID. Referring back to the digital packet 1101, which includes a block for destination, just as that destination may be filled in with a user ID (for the intended recipient), that block may be filled in with a group ID. Noting again that when a device 101 sends a signal, the device 101 “broadcasts” the signal such that receipt is dependent upon a server or recipient device reading its own ID, the transmitted signal may encode a packet with a recipient group ID. This methodology is no mere convenience, like an email list or friend group on a social network. Instead, management of group ID minimizes network resource (and satellite time and bandwidth, in particular) where systems of the invention are being used for multi-user deployments. For example, a fleet manager may wish to install a device in every truck of a delivery fleet for a large, global retailer. Then, every dispersed user may receive a message (e.g., “shift change”) while requiring the admin to send only one uplink message to a satellite 312.

The system 301 preferably employs a certain software architecture For example, the software architecture may comprises a separates backend that allows querying through a standard API.

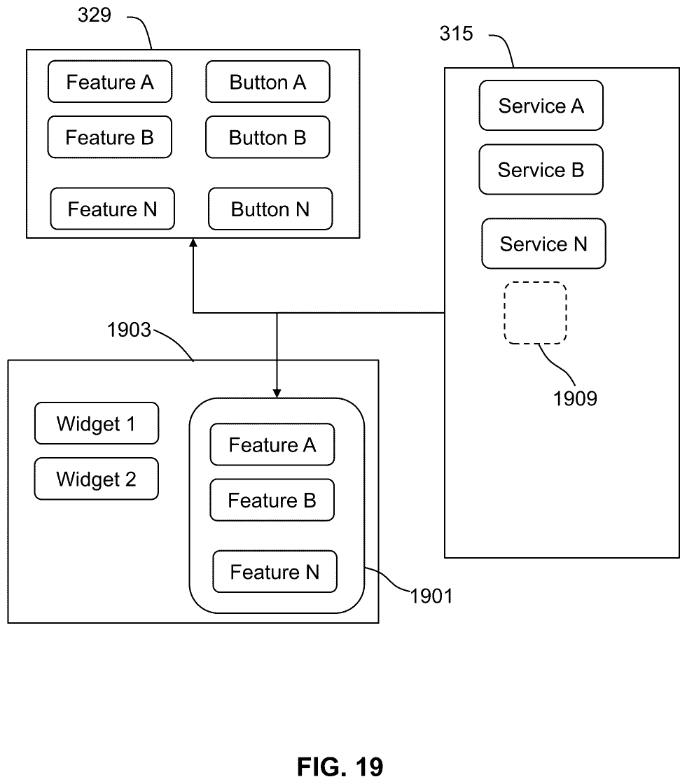

FIG. 19 illustrates part of the software architecture according to certain embodiments. The server system 315 generally provide a set of services A, B, . . . N. The server system also provides a defined application programming interface (API) 1909. The app 329 (provided by the system), which is operating on local computing device such as a smartphone, can provide an end-user with a set of features A, B, . . . N corresponding to the provided services. As shown, the App 329 may present a set of button A, B, . . . N (or other controls) by which the user may invoke the functionality of the services A, B, . . . N.

Due to the API 1909, a third-party environment or application 1903 may interact with the system 301 via the API 1909. In fact, the third party application 1903 may install a system widget 1901 (e.g., downloaded from the server system 315) alongside its own third party widgets 1, 2. The system widget 1901 operates on the third party application 1903 to provide a user of that application 1903 with the set of features A, B, . . . N that are embodied in the services A, B, . . . N provided by the server system 315, all mediated by interactions through the API 1909.

When accessing the backend via the API, all reflected services and operations become accessible to an end user. The system may provide end-users with the ability to access and install ready-to-run PC and mobile applications. The system may also provide a defined application-programming-interface, allowing a third-party end-user to integrate all backend system capabilities into third party enterprise software. To give but one example, an auto manufacturer may wish to install the system widget 1901 within the in-dash navigation system of a line of automobiles to give future purchases the option to use location sharing and SOS functionality provided by the system 301. The manufacturer could also install a fleet version of device 101 on a firewall of the auto, connected to a rooftop antenna and to the vehicles 12V supply. Instead of installing the standalone app 329 in an iOS device, the manufacturer could install the system widget 1901, allowing the widget 1901 into initiate messaging, using the fleet device 101 and the connected antenna, to modulate a digital package comprising the SOS message and location coordinates by chirp spread spectrum or similar (e.g., LoRa) and send via the antenna over a designated band of frequency such as the L-band to a GEO satellite for management by the system 301. Such a version may be useful to a rental car company, further allowing the company to track locations of a fleet of rental vehicles using GPS information from the plurality of satellite communication devices. Continuing with this simple, illustrative example, devices 101 of the system 301 may be particularly attractive to a rental car company due to the described beam-hopping mechanism. The system widget 1901 and the installed device 101 use a database representing geographical extent of beams of a satellite as polygons and, as a vehicle moves, the device 101 obtains coordinates for a current location by GPS and selects an active polygon representing an active beam of the satellite within which to transmit the message.

What is claimed is:

1. A satellite communication system comprising:
a server system having stored therein identities of a plurality of satellite communication devices;
a transceiver array communicatively positioned between the server system and a satellite ground station receiving transmissions from a satellite, wherein the transceiver array is operable to
receive a modulated signal from the satellite via the satellite ground station,
demodulate the signal into a digital packet, and
send the digital packet via internet protocol (IP) to the server system, wherein the server system reads an identify of a recipient device from the packet and operates the transceiver array to modulate the packet by spread spectrum modulation and send the packet to the recipient device via satellite.

2. The system of claim 1, wherein the spread spectrum modulated signal uses about 8 KHz of spectrum or less.

3. The system of claim 1, wherein the satellite communicates with the satellite communication devices by a plurality of beams, wherein each satellite channel has a bandwidth of about 25 KHz and wherein the server system is operable to use the transceiver array to simultaneously send multiple signals using one beam of the satellite.

4. The system of claim 1, wherein the transceiver array comprises a plurality of hardware satellite communication devices, wherein each device of the plurality of hardware satellite communication devices comprises a microcontroller unit coupled to a transceiver unit, wherein each device can simultaneously send or receive at least about three packets, whereby the transceiver array can operate the plurality of hardware satellite communication devices to simultaneously send or receive dozens or more of the packets.

5. The system of claim 1, further comprising a hub, wherein the hub comprises at least ground-based transceiver device coupled to a local hub computer, wherein the hub is remote from any satellite ground station, wherein the hub is operable to relay a transmission from a first device to a second device of the plurality of satellite communication devices through a satellite using a first channel on a satellite beam for the first device and a second channel on the satellite beam or the second device.

6. The system of claim 5, wherein the hub communicates the transmission via chirp spread spectrum modulation, phase shift keying, frequency shift keying, or amplitude shift keying modulation with the satellite in an L-band or C-Band.

7. The system of claim 5, wherein the hub demodulates the transmission to read a digital packet, wherein a header of the packet identifies the second device as an intended recipient, and wherein the hub verifies, optionally using a database and/or GPS or GNSS on the second device, that the second device is within the satellite beam.

8. The system of claim 1, further comprising:
at least one device of the plurality of satellite communication devices, the one device comprising (i) a transceiver unit operable to transmit a message from the one device to the satellite, (ii) a controller unit coupled to the transceiver unit and operable to control operations of the transceiver unit, and (iii) a connection subsystem that communicatively couples the device with a local computing device; and
an app on the local computing device, the app offering an end-user the ability to use the one device for push-to-talk communication and text messaging.

9. The system of claim 8, wherein information identifying at least one device is stored within the server system.

10. The system of claim 8, wherein the end-user uses the app to compose and send a text message from the local computing device to a second device of the plurality of satellite communication devices, wherein the app writes the text message as a digital packet and sends the digital packet via a personal area network (PAN) connection to the one device.

11. The system of claim 10, wherein the one device: receives the digital packet via the PAN connection; generates, using a modulation technique selected from the group consisting of chirp spread spectrum modulation, phase shift keying, and amplitude shift keying by the transceiver unit, an RF signal that contains the digital packet; and sends the RF signal via an L-Band to the satellite, also wherein the PAN connection uses a Bluetooth low energy (BLE) connection.

12. The system of claim 11, wherein the satellite sends the RF signal to the satellite ground station, wherein the transceiver array relays the digital packet to the server system.

13. The system of claim 11, wherein the end-user selects a message recipient using the app, wherein the app encodes the recipient in bits within the digital packet, wherein the server system identifies the recipient as a registered user of the system and routes the digital packet to a receiving one of the plurality of satellite communication devices being used by the message recipient.

14. The system of claim 8, wherein the app determines that a cellular network is available to the local computing device and wherein the app sends the message to the server system via the cellular network.

15. The system of claim 8, wherein the one device and a second device of the plurality of satellite communication devices are both registered in the server system and wherein, when the one device and second device are within a beam of the satellite, the one device and the second device can send messages to each other via only the satellite without the message passing through the server system, the transceiver array, or a terrestrial hub.

16. The system of claim 8, wherein the one device and the recipient are both registered in the server system and wherein, when the one device is within a beam of the satellite and when the recipient has a smartphone within a cellular network, the one device sends a message via the satellite to through the server system, onto the cellular network and to the recipient smartphone.

17. The system of claim 15, wherein the one device performs chirp spread spectrum modulation on a digital packet that includes bits identifying the second device and sends the modulated digital packet via the L-band to the satellite, wherein the satellite performs a bent-pipe return to pass the modulated digital packet via the L-band to the second device, wherein the second device reads the bits identifying the second device and passes the digital packet via BLE to a second smartphone.

18. The system of claim 8, wherein the one device and a second device of the plurality of satellite communication devices are both registered in the server system and wherein, when the one device and second device are within a cellular network, the devices communicate via the cellular network.

19. The system of claim 8, wherein the one device and a second device of the plurality of satellite communication devices are both registered in the server system and wherein the one device and second device can exchange messages by each of the following routings according to availability of system components:
(i) the one device to the second device via single 8 KHz channel through one satellite acting as a bent pipe;
(ii) the one device to the second device via a terrestrial hub using two 8 KHz channels;
(ii) first smartphone paired to the one device to second smartphone paired to the second device via cellular network;
(iii) the one device to the second device through the satellite ground station, the transceiver array, and the server system; and
(iv) the one device to the second smartphone paired to the second device by sending pre-programmed message stored in memory of the one device to the satellite.

20. The system of claim 1, wherein one or more of the plurality of satellite communication devices are installed on vehicles of a fleet, wherein the server system tracks locations of the vehicles of the fleet using GPS information from the plurality of satellite communication devices.

21. The system of claim 1, wherein the server system or each device maintains a database representing geographical extent of beams of the satellite as polygons, and wherein each of the plurality of satellite communication devices operates to change a beam using a global positioning system (GPS) coupled to a controller unit within the device, wherein the controller unit is operable to obtain coordinates for a current location of the device from the GPS and select from the polygons an active polygon representing an active beam of the satellite within which to transmit the message.

22. The system of claim 1, wherein the server system maintains a user ID for each of the stored identities of the plurality of satellite communication devices, each user ID being associated with a user, further wherein the server system allows each user ID to be associated with one or more group IDs and wherein the digital packet includes a user ID or group ID as the recipient.
